(19) United States
(12) Patent Application Publication
(10) Pub. No.: US 2021/0073843 A1
(43) Pub. Date: Mar. 11, 2021

(54) SYSTEM, DEVICE, AND METHOD TO MANAGE ELECTRONIC PROMOTIONAL CAMPAIGN RECORDS

(71) Applicant: IGT, Las Vegas, NV (US)

(72) Inventors: Jeffery Shepherd, Reno, NV (US); Marc Espin, Sparks, NV (US); Kevin Higgins, Reno, NV (US)

(21) Appl. No.: 16/566,325

(22) Filed: Sep. 10, 2019

(51) Int. Cl. G06Q 30/02; G07F 17/32

(52) U.S. Cl. CPC G06Q 30/0212; G06Q 30/0225; G07F 17/3255; G06Q 30/0209; G06Q 30/0237

(57) ABSTRACT

A method, server, and system for managing electronic records is provided. As an example, a method is provided that includes receiving an entitlement redemption message from a communication device, where the entitlement redemption message includes a campaign identifier and an entitlement identifier, determining that the campaign identifier and the entitlement identifier belong to a valid campaign, generating, in response to determining that the campaign identifier and the entitlement identifier belong to a valid campaign, an electronic record for a ticket with a redeemable status, where the electronic record for the ticket is associated with the entitlement identifier and includes a ticket validity period and a ticket redemption amount, and transmitting a ticket presentation message that includes an indication of the ticket validity period and the ticket redemption amount.

### BACKGROUND

The present disclosure is generally directed toward managing electronic records for promotional campaigns.

Promotional coupons, which have also been historically referred to as promotional tickets, have been used within gaming environments and casinos to help improve player experiences and offer new services to players during their interactions with the casino. Many promotional coupons are funded by the casino, typically by marketing dollars, and are given to players during various promotional campaigns. Today, when a promotional campaign generates tens of thousands of tickets, the campaign requires an equal number of validation codes to be consumed from a finite set of possible validation codes, risking that the set of possible validation codes could be exhausted if the campaign operator runs too many marketing campaigns that issue promo tickets. In the case of a casino promotional campaign, the finite set of possible validation codes are also used by Ticket-In-Ticket-Out (TITO) tickets. This means that large promotional campaigns may run the risk of exhausting the total range of validation codes that are available for TITO tickets.

### BRIEF SUMMARY

In some embodiments, a method of facilitating database management for entitlements is provided that includes: receiving, at a server, an entitlement redemption message from a communication device, where the entitlement redemption message includes a campaign identifier and an entitlement identifier; determining, at the server, that the campaign identifier and the entitlement identifier belong to a valid campaign; generating, at the server and in response to determining that the campaign identifier and the entitlement identifier belong to a valid campaign, an electronic record for a ticket with a redeemable status, where the electronic record for the ticket is associated with the entitlement identifier and includes a ticket validity period and a ticket redemption amount; and transmitting, from the server, a ticket presentation message that includes an indication of the ticket validity period and the ticket redemption amount.

In some embodiments, a server is provided that includes: a processor and a computer-readable storage medium coupled with the processor and including instructions that are executable by the processor, where the instructions include: a set of instructions that receive an entitlement redemption message including a campaign identifier and an entitlement identifier; a set of instructions that determine the campaign identifier and entitlement identifier belong to a valid campaign; a set of instructions that generate, in response to determining that the campaign identifier and entitlement identifier belong to a valid campaign, an electronic record for a ticket with a redeemable status, where the electronic record for the ticket is associated with the entitlement identifier and includes a ticket validity period; and a set of instructions that cause a ticket presentation message to be transmitted to a communication device, where the ticket presentation message includes an indication of the ticket validity period.

In some embodiments, a system is provided that includes: a network interface that facilitates machine-to-machine communications via a communication network; a processor coupled with the network interface; and computer memory coupled with the processor, the computer memory including processor-executable instructions that, when executed by the processor, cause the processor to: receive an entitlement redemption message including an entitlement identifier; determine the entitlement identifier belongs to a valid campaign; generate, in response to determining that the entitlement identifier belongs to a valid campaign, an electronic record for a ticket with a redeemable status, where the electronic record for the ticket is associated with the entitlement identifier and includes a ticket validity period; and cause a ticket presentation message to be transmitted to a communication device, where the ticket presentation message includes an indication of the ticket validity period.

Additional features and advantages are described herein and will be apparent from the following Description and the figures.

### BRIEF DESCRIPTION OF THE SEVERAL VIEWS OF THE DRAWINGS

FIG. 1 is a block diagram of a system accordance with embodiments of the present disclosure;

FIG. 2A is a block diagram depicting an illustrative data structure used in accordance with embodiments of the present disclosure;

FIG. 2B is a block diagram depicting additional details of the data structure in accordance with embodiments of the present disclosure;

FIG. 3 is a block diagram depicting an illustrative gaming device in accordance with embodiments of the present disclosure;

FIG. 4 is a block diagram depicting a mobile device in accordance with embodiments of the present disclosure;

FIG. 5 is a flow diagram depicting a first method in accordance with embodiments of the present disclosure;

FIG. 6 is a flow diagram depicting a second method in accordance with embodiments of the present disclosure; and

FIG. 7 is a flow diagram depicting a third method in accordance with embodiments of the present disclosure.

### DETAILED DESCRIPTION

Embodiments of the present disclosure provide a mechanism for mitigating issues associated with implementing a promotional campaign in which coupons are offered to guests, players, or potential patrons of an enterprise (e.g., a casino). Specifically, as discussed above, traditional implementations of promotional campaigns required the generation of tens of thousands of coupons and further required an equal number of validation codes to be consumed from a finite set of possible validation codes. In some embodiments, this finite set of possible validation codes may correspond to TITO validation codes that must meet certain range and formatting constraints. Embodiments of the present disclosure present the concept of a promotional coupon entitlement, whose range is much larger than the range of codes used as TITO validation codes due to the TITO validation codes being constrained by legacy decisions. Previous 1:1 constraints created a risk that the set of possible validation codes (or TITO validation codes) could be exhausted if the campaign operator runs too many marketing campaigns that issue promotional coupons. Embodiments of the present disclosure mitigate this issue by using a just-in-time promotional ticket scheme and promotional coupon entitlements. The proposed system, method, and devices help facilitate the electronic distribution of promotional coupons without risking a complete use of a finite set of validation codes, such as TITO validation codes.

In some embodiments, a system is contemplated that enables the creation of promotional campaigns similar to how campaigns are currently created, except that rather than creating a promotional coupon that immediately consumes a validation code, an alternative record (e.g., a promotional coupon entitlement) is created. A promotional coupon entitlement or “entitlement” will be described as an electronic record that is represented by its own unique identifier (e.g., an entitlement identifier). The entitlement can be later redeemed by the player in exchange for a valid promotional “ticket.” The unique identifier on the entitlement may be determined from a limited or finite set of identifiers, but the set will be much larger than what is available for ticket identifiers; therefore, the size of the entitlement identifier finite set will be, for all practical purposes, infinite.

In some embodiments, the entitlement identifier may be provided in a predetermined alphanumeric format. As a non-limiting example, an entitlement identifier may be provided as a Globally Unique Identifier (GUID), a Universally Unique Identifier (UUID), or any other sequence that can be used to identify information within a computing system. A GUID or UUID may correspond to a 128-bit number that is used to uniquely identify an entitlement within the system that is implementing the promotional campaign. Alternative approaches are also contemplated for an entitlement identifier, such as utilizing a randomly-defined integer value of a very large size. In some embodiments, the entitlement identifier may be provided in a format that prevents persons from easily or reasonably guessing a number, as that behavior would allow malicious persons to lay claim to a promotional entitlement that was actually issued to another player, patron, or potential patron.

In some embodiments, a system is provided that enables a promotional campaign and associated entitlements to be created. The entitlement may include most, if not all, of the values that were previously used to create promotional tickets except for the ticket validation codes/ticket identifiers. In other words, an electronic record associated with an entitlement may include a timestamp, a campaign identifier, an entitlement identifier (e.g., an entitlement GUID), a validity period, and an entitlement amount. The entitlement may be marked with an “issued” or “redeemable” state in the campaign database. The entity executing the promotional campaign may then send the generated entitlements to persons by any delivery channel desired (e.g., postal mail, via an electronic medium, such as e-mail or SMS text, etc.). When a person receives the entitlement, which is either in physical form or electronic form, the person can then return to the entity executing the promotion (e.g., a casino) and present the entitlement (e.g., at the cashier cage of the casino). The entity's authorized personnel could look up the entitlement and verify whether or not the entitlement belongs to a valid promotional campaign. At this point the personnel could command the system to create a promotional ticket for the person. It should be appreciated that authorized personnel may not be required to execute entitlement redemption. Rather, a person may be allowed to redeem an entitlement by themselves using an appropriate redemption device (e.g., the person's mobile device, a gaming machine, a wager terminal, a kiosk, or any other capable gaming device).

In some embodiments, entitlements are printed out and the entitlement identifier (e.g., entitlement GUID) is printed on the entitlement and is in a format that it can be read electronically by an optical device (e.g., by using Optical Character Recognition (OCR) technology). In some embodiments, the entitlement can be printed with a graphic that is representative of the entitlement identifier and that graphic is readable by an optical device such that the entitlement identifier is resolved from the graphic (e.g., the entitlement identifier can be encoded as a QR code, barcode, or the like).

In some embodiments, the entitlement may be transferred to the patron electronically (e.g., via email, text, etc.) as an image with either the entitlement identifier, graphic, or both as described above. The patron may print out the entitlement and present it at the casino, or the patron may present the image at a cashier or kiosk and, upon validation, of the entitlement, the patron will receive a promotional ticket. In another embodiment, the entitlement could be a QR-code or NFC-enabled pass for an electronic wallet platform (e.g., Google Wallet, Apple Wallet, or other mobile wallet.).

In creating the promotional campaign that results in the entitlements being created, the campaign and entitlements could be created wholly inside a casino system or in a secondary system, such as a marketing system. In one embodiment, the campaign could be created in the secondary system and communicated to casino system over an interface and the casino system could create the entitlements associated with the campaign. In another embodiment, both the campaign and the entitlements could be created outside of casino system by the secondary system and the resulting data could be communicated to casino system. In some embodiments, the campaign and entitlements could be created outside of the casino system by the secondary system, and the associated redemption of the entitlement could be managed outside of casino system by the secondary system. The entitlement redemption would then trigger the secondary system to communicate with casino system over an interface to issue the appropriate associated ticket consistent with information contained in the entitlement.

In some embodiments, a mobile device may be configured to interact with a gaming machine or wager terminal to redeem the entitlement and/or ticket. In some embodiments, the mobile device, having the entitlement stored locally on memory the mobile device, can pair with the gaming machine or wager terminal using any type of communication protocol (e.g., Bluetooth®, NFC, optical/QR code-based pairing, etc.). The mobile device can then send the entitlement data to the gaming machine or wager terminal, and then the gaming machine or wager terminal can transmit the entitlement data to the casino system to facilitate redemption. In some embodiments, the casino system can be configured to validate the entitlement and command the gaming machine or wager terminal to print the appropriate promotional ticket. In some embodiments, the mobile device can similarly be paired to the gaming machine or wager terminal, but the mobile device can interact with casino system over an interface passing the entitlement data and the identity of the gaming machine or wager terminal to the casino system. The casino system can then validate the entitlement and command the gaming machine or wager terminal to print the appropriate promotional ticket. In a case where the entitlement is not stored in memory of the paired mobile device, but is stored in memory of a casino system or a player wallet administered by the casino system, the mobile device can interact with the casino system, select the entitlement, submit it to the casino system. The casino system can then validate the entitlement, redeem the entitlement, and command the gaming machine or wager terminal to print the promotional ticket. It should be appreciated that while a gaming machine and/or wager terminal are described as having particular capabilities within the casino system, the components (e.g., a Slot Machine Interface Board (SMIB), a modem, or the like) can be used to facilitate some or all of the functionality described in connection with a gaming machine and/or wager terminal.

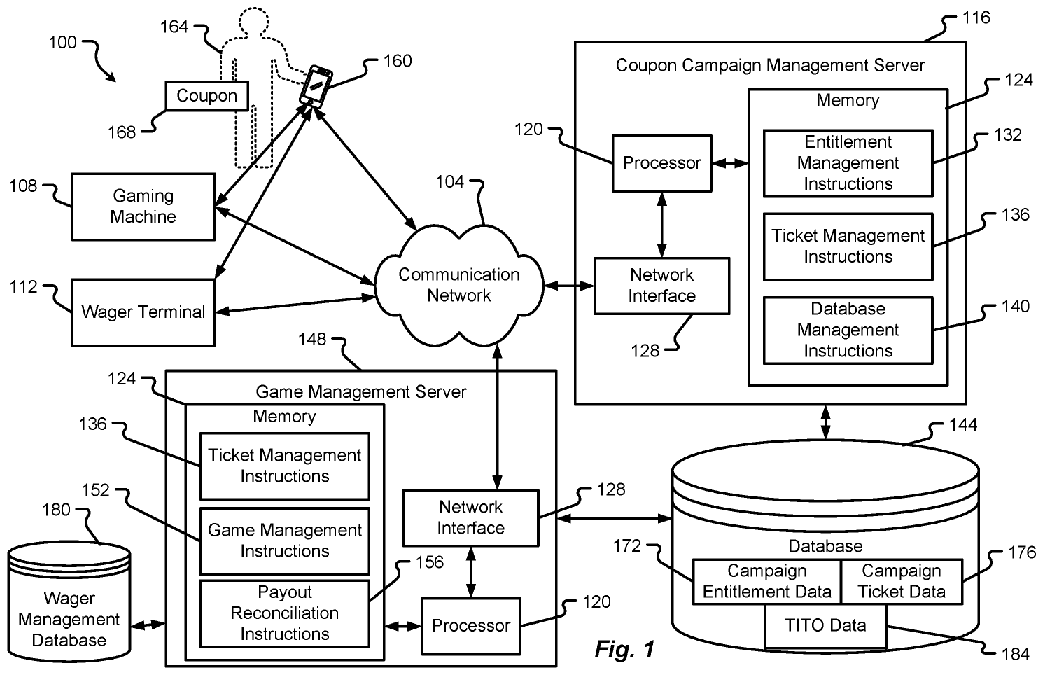

With reference initially to FIG. 1, details of an illustrative system 100 will be described in accordance with at least some embodiments of the present disclosure. The components of the system 100, while depicted as having particular instruction sets and devices, is not necessarily limited to the examples depicted herein. Rather, a system according to embodiments of the present disclosure may include one, some, or all of the components depicted in the system 100 and does not necessarily have to include all of the components in a single device. For instance, the components of a server may be distributed amongst a plurality of servers and/or other devices (e.g., a gaming machine, a wager terminal, a mobile device, etc.) in the system 100 without departing from the scope of the present disclosure.

The system 100 is shown to include a communication network 104 that interconnects and facilitates machine-to-machine communications between one or multiple gaming machines 108, a wager terminal 112, a coupon campaign management server 116, and a game management server 148. It should be appreciated that the communication network 104 may correspond to one or many communication networks without departing from the scope of the present disclosure. In some embodiments, the various gaming machines 108 and server(s) 116, 148 may be configured to communicate using various nodes or components of the communication network 104. The communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, gaming machines 108, wager terminals 112, and other devices described herein may be distributed throughout a single property or premises (e.g., a single casino floor) or gaming machines 108 and wager terminals 112 may be distributed among a plurality of different properties. Gaming machines 108, wager terminals 112, and mobile devices 160 may correspond to specific but non-limiting examples of a gaming device.

In a situation where the gaming machines 108 and wager terminals 112 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The gaming machines 108, as one example of a gaming device, may utilize the same or different types of communication protocols to connect with the communication network 104. It should also be appreciated that different gaming machines 108 may or may not present the same type of game to a player 164. Likewise, wager terminals 112, as another example of a gaming device, may or may not enable the player 164 to wager on the same types of events or redeem tickets based on outcomes of wagered events. It should also be appreciated that the servers 116, 148 may or may not be co-located with one or more gaming machines 108 or wager terminals 112 in the same property or premises. Thus, one or more gaming machines 108 may communicate with the game management server 148 over a WAN, such as the Internet. Likewise, one or more wager terminals 112 may communicated with the game management server 148 over a WAN. These same devices may communicate with the coupon campaign management server 116 via a WAN or LAN, depending upon the configuration of the system 100. In the event that a WAN or similar type of untrusted communication network 104 is used between components, a tunneling protocol or Virtual Private Network (VPN) may be established over some of the communication network 104 to ensure that communications between nodes within a casino and a remotely-located node are secured.

The gaming machines 108 may correspond to a type of gaming device that enables player 164 interaction in connection with playing games of chance, games of skill, hybrid games of chance/skill, and/or place wagers on events (e.g., sporting competitions, races, etc.). The gaming machine 108 may also be configured as a terminal at which the player 164 can redeem a coupon 168. As will be discussed in further detail herein, the coupon 168 may correspond to a physical object or data object (e.g., electronic record stored in memory of the player's 164 mobile device 160) that is initially created by the coupon campaign management server 116 as an entitlement. The coupon 168, when presented as an entitlement, may not correspond to an object that is immediately redeemable as a ticket within the casino system (e.g., the gaming functionality provided by the game management server 148 and/or gameplay functionally provided by a gaming machine 108 or wager terminal 112). Rather, redemption of the coupon 168 as an entitlement may cause the coupon campaign management server 116 and/or game management server 148 to issue a corresponding ticket to the player 164, where the ticket issued to the player 164 is redeemable within the casino system. In some embodiments, the gaming machine 108, wager terminal 112, and/or mobile device 160 may also correspond to devices at which the player 164 can redeem a ticket as will be described in further detail herein. Thus, both entitlements and tickets associated with a promotional campaign managed by the coupon campaign management server 116 may be redeemable at a gaming machine 108, wager terminal 112, mobile device 160, and/or at a predetermined location within a casino (e.g., a casino cage) by authorized personnel of the casino.

The wager terminal 112 may also correspond to a gaming device that enables a player 164 to place wagers on events and to redeem entitlements and/or tickets. The wager terminal 112 may or may not enable the player 164 to interact with games of chance, games of skill, or hybrid games of chance/skill.

The player 164 may also be allowed to interact with games of chance, games of skill, hybrid games of chance/skill, and/or place wagers via their mobile device 160. In some embodiments, the mobile device 160, may operate as a remote control for a gaming machine 108 or wager terminal 112. In other embodiments, the mobile device 160 may operate similarly to a gaming machine 108 (e.g., by executing a local gaming application or by enabling a web-based interaction with a gaming application) and/or wager terminal 112 (e.g., by executing a local event wager application or by enabling a web-based interaction with an event wager application operating on the game management server 148). A mobile device 160 may correspond to a player's 164 personal device or to a device issued to the player 164 during the player's visit at a particular casino. It should be appreciated that the player 164 may play games directly on their mobile device 160 and/or the mobile device 160 may be in communication with a gaming machine 108 or wager terminal 112 such that the mobile device 160 provides the interface for the player 164 to the gaming machine 108 or wager terminal 112. As shown in FIG. 1, the mobile device 160 may be in communication with the communication network 104 or in direct communication (e.g., via Bluetooth®, WiFi, NFC, etc.) with a gaming machine 108 or wager terminal 112. In a situation where the mobile device 160 is in direct communication with the gaming machine 108 or wager terminal 112, a proximity-based communication protocol such as Bluetooth®, WiFi, NFC, or the like, may be used to establish a proximity-based communication channel between the devices. Non-limiting examples of a mobile device 160 include a cellular phone, a smart phone, a tablet, a wearable device, an augmented reality headset, a virtual reality headset, a laptop, a Personal Computer (PC), or the like.

The coupon campaign management server 116 is further shown to include a processor 120, memory 124, and a network interface 128. These resources may enable functionality of the coupon campaign management server 116 as will be described herein. For instance, the network interface 128 provides the coupon campaign management server 116 with the ability to send and receive communication packets or the like over the communication network 104. The network interface 128 may be provided as a network interface card (NIC), a network port, drivers for the same, and the like. Communications between the components of the coupon campaign management server 116 and other devices connected to the communication network 104 may all flow through the network interface 128.

The processor 120 may correspond to one or many computer processing devices. For instance, the processor 120 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 120 may be provided as a microprocessor, Central Processing Unit (CPU), or plurality of microprocessors that are configured to execute the instructions sets stored in memory 124. Upon executing the instruction sets stored in memory 124, the processor 120 enables various functions of the coupon campaign management server 116.

The memory 124 may include any type of computer memory device or collection of computer memory devices. The memory 124 may be volatile or non-volatile in nature and, in some embodiments, may include a plurality of different memory devices. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. In some embodiments, the memory 124 may include instructions that enable the processor 120 to store, manage, and interact with data stored in a database 144. The instructions stored in memory 124 that provide this capability are shown as a database management instruction set 140. When executed by the processor 120, the database management instruction set 140 may be configured to write data to, read data from, and modify data stored in the database 144. As will be discussed in further detail herein, the database 144 may be used to store campaign entitlement data 172, campaign ticket data 176, and or ticket-in-ticket-out (TITO) data 184. The entitlement data 172 and campaign ticket data 176 may be associated with various promotional campaigns being provided and managed by the coupon campaign management server 116. The TITO data 184 may be associated with gameplay activity managed by the game management server 148. In some embodiments, a common pool of ticket identifiers may be assigned to ticket identifiers as campaign ticket data 176 managed by the coupon campaign management server 116 in addition to being assigned to TITO tickets managed by the game management server 148. As will be discussed in further detail herein, the campaign entitlement data 172 may encompass a number of data fields used to manage and track entitlements issued by the coupon campaign management server 116. The campaign ticket data 176 may correspond to data that is generated in response to a valid entitlement being redeemed by the player 164. In some embodiments, the entitlements associated with a promotional campaign may be generated and issued by the coupon campaign management server 116. When an entitlement is redeemed, the entitlement may be analyzed by the coupon campaign management server 116 to confirm that the entitlement belongs to a valid campaign. After such verification, the coupon campaign management server 116 may be configured to update the database 144 and write campaign ticket data 176 into the database 144 that represents a redeemable ticket generated in response to the redemption of the entitlement. Similarly, when a gaming machine 108, wager terminal 112, or the like print a ticket indicating a player's 164 available gameplay credits when the player cashes-out, the game management server 148 may update the TITO data 184 with a ticket identifier that was assigned to the printed ticket. Because both the game management server 148 and coupon campaign management server 116 are issuing ticket identifiers from the same common pool of ticket identifiers, it is beneficial to allow the coupon campaign management server 116 to initially assign entitlement identifiers to coupons 168 until such time as the entitlement is redeemed. At the point of an entitlement redemption, the coupon campaign management server 116 may then obtain a ticket identifier from the shared pool of ticket identifiers and assigned the ticket identifier to a redeemable ticket as part of the coupon campaign.

Although depicted as a separate database, any of the information stored in the database 144 may be stored in memory 124 of the coupon campaign management server 116, in memory of the game management server 148, in memory of the mobile device 160, or in combinations thereof. In other words, the data structures described as being maintained in the database 144 do not necessarily need to solely reside within the database 144, but rather can be distributed among memory devices of other components in the system 100.

The other illustrative instruction sets that may be stored in memory 124 of the coupon campaign management server 116 include, without limitation, an entitlement management instruction set 132 and a ticket management instruction set 136. Functions of the coupon campaign management server 116 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the coupon campaign management server 116. Said another way, the particular instruction sets depicted in FIG. 1 should not be construed as limiting embodiments described herein.

In some embodiments, the entitlement management instruction set 132, when executed by the processor 120, may enable the coupon campaign management server 116 to generate entitlements and appropriate campaign entitlement data 172 for a promotional campaign, process entitlement redemption attempts, verify and validate entitlement redemptions as being associated with a valid promotional campaign, and invoke the ticket management instructions 136 to generate corresponding redeemable tickets along with associated campaign ticket data 176.

The ticket management instruction set 136, when executed by the processor, may enable the coupon campaign management server 116 to perform any task associated with generating/creating, storing, organizing, analyzing, or reporting events related to a ticket. In some embodiments, the ticket management instruction set 136 may also enable cooperative interactions with the game management server 148. For instance, as tickets are generated by the ticket management instruction set 136 and/or valid tickets are redeemed with verification by the ticket management instruction set 136, the ticket management instruction set 136 may notify the game management server 148 of such events, thereby enabling the game management server 148 to control appropriate behaviors within the casino system (e.g., instruct a gaming machine 108 and/or wager terminal 112 to print a physical ticket consistent with a ticket generated by the ticket management instruction set 136.

The game management server 148 is depicted as being separate from the coupon campaign management server 116, but it should be appreciated that a single server can be configured with the capabilities of both servers 116, 148. The game management server 148 is also shown to include a processor 120, memory 124, and network interface 128. The game management server 148 may be configured to specifically manage activities, messages, and notifications related to games played at gaming machines 108, wagers placed or redeemed at the gaming machine 108, wagers placed or redeemed at the wager terminal 112, wagers placed or redeemed at the mobile device 160, and the like. As an example, the game management server 148 may be configured to interact with gaming machines 108, wager terminals 112, and/or mobile devices 160 to allow the player 164 to place wagers on events, cause physical tickets to be printed in response to an entitlement being redeemed by a player 164, cause digital tickets to be printed in response to an entitlement being redeemed by a player 164, determine when events have concluded, update credit meters at a gaming machine 108 and/or wager terminal 112 in response to ticket redemptions, and determine whether any wagers placed on an event should be paid or not based on the outcome of the event.

The memory 124 of the game management server 148 may be provided with instruction sets that enable these and other functions related to game management, wager management, ticket-in-ticket-out (TITO) management, and the like. The illustrative types of instruction sets that may be stored in the game management server 148 include, without limitation, a ticket management instruction set 136, a game management instruction set 152 and a payout reconciliation instruction set 156.

The ticket management instruction set 136, when executed by the processor 120, may enable the game management server 148 to provide TITO functionality to the player 164 via a gaming machine 108, wager terminal 112, mobile communication device 160, or combinations thereof. In some embodiments, TITO functionality provided by the game management server 148 is made possible by the execution of the ticket management instructions 136 on the game management server 148. The ticket management instructions 136 may enable the game management server 148 to track tickets printed at gaming machines 108 or wager terminals 112 during player 164 cashout, associate a ticket identifier with an amount of available credits during cashout, store the ticket identifier and credit information at TITO data 184 in the database 144, determine the ticket is later presented at another device for redemption (e.g., during a redemption for cash or redemption for credits at another gaming machine 108, wager terminal 112, or mobile communication device 160), determine the amount of available credits to issue in response to the ticket redemption, and manage the TITO data 184. Although the ticket management instruction set 136 is described as enabling TITO functionality at the game management server 148, it should be appreciated that a separate server (e.g., separate from the coupon campaign management server 116 and game management server 148) may be provided with the ticket management instruction set 136 to enable TITO functionality.

The game management instruction set 152, when executed by the processor 120, may enable the game management server 148 to manage the various games played by a player 164 at the gaming machines 108. Alternatively or additionally, the game management instruction set 152 may track wagers placed by the player 164 at a gaming machine 108, wager terminal 112, and/or mobile device 160 and may help store information related to such wagers in a wager management database 176. In some embodiments, the game management instruction set 152 may also be configured to track a status of wager events (e.g., sporting events, race events, bingo, keno, lottery, etc.) and whether a player 164 has placed a wager on such events. In some embodiments, when a wager event has come to completion such that wagers made on the event become payable (e.g., at the end of a sporting event when the final score of the event is determined), the game management instruction set 152 may notify the payout reconciliation instruction set 156, thereby enabling the payout reconciliation instruction set 156 to update the wager management database 176 and send appropriate notification messages to the gaming machine 108, wager terminal 112, coupon campaign management server 116, and/or mobile device 160 to notify such devices of the event outcome and the related outcome of the wager(s) placed on the event. The payout reconciliation instruction set 156 may also be configured to enable communications with the coupon campaign management server 116 for purposes of exchanging messages regarding issued tickets, ticket validity periods, redeemed tickets, and redemption amounts associated with tickets.

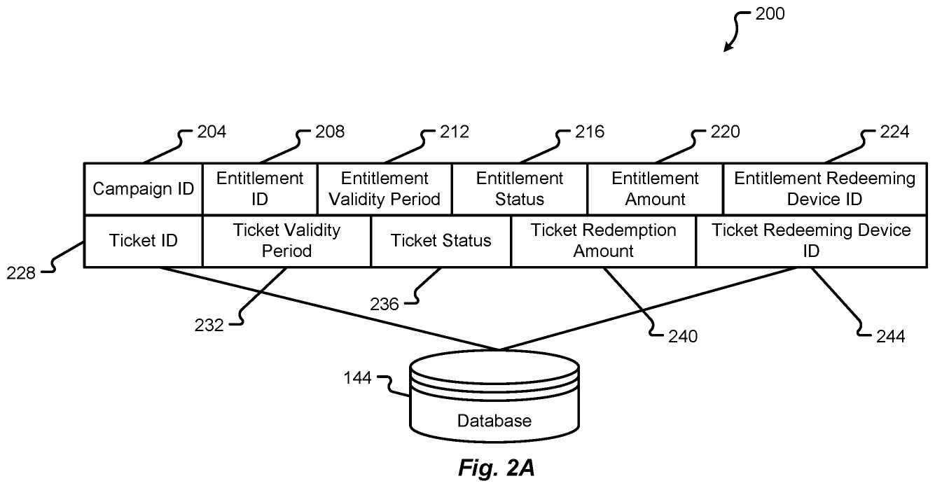

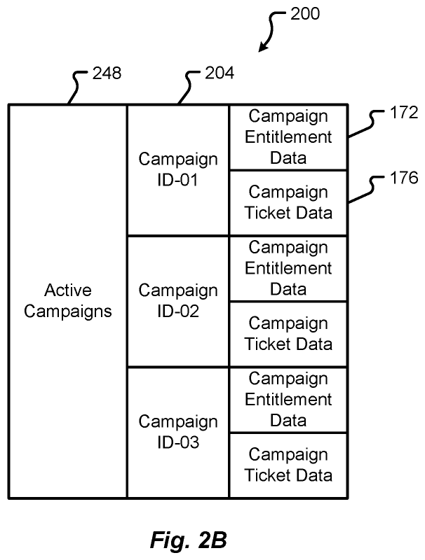

With reference now to FIGS. 2A and 2B, additional details of data structures 200 that are useable in connection with managing electronic records of entitlements, managing electronic records of tickets, and/or managing data associated with a campaign being administered by the coupon campaign management server 116 will be described in accordance with at least some embodiments of the present disclosure. It should be appreciated that the data structures 200 depicted and described herein may be stored within a central database or may be distributed among a number of data storage nodes. Alternatively or additionally, some or all of the fields of the data structures may be maintained in devices of the system 100 such as the gaming machine 108, the wager terminal 112, the coupon campaign management server 116, the game management server 148, and/or the mobile device 160 without departing from the scope of the present disclosure.

In some embodiments, the data stored in the data structure 200 may be stored for a plurality of different campaigns. Specifically, as depicted in FIG. 2B, each campaign may have an active campaign identifier 204 associated therewith that uniquely identifies the campaign among other active campaigns 248 being managed by the coupon campaign management server 116. In some embodiments, each active campaign 248 may have campaign entitlement data 172 and campaign ticket data 176 associated therewith. Details of the campaign identifiers 204, the campaign entitlement data 172, and the campaign ticket data 176 will now be described with reference to the data structure 200 depicted in FIG. 2A.

As shown in FIG. 2A, the data structure 200 may include a number of data fields that are used to store the campaign identifier 204 along with campaign entitlement data 172 and campaign ticket data 176 within the database 144. The data structure 200 may also be used to store TITO data 184, which corresponds to data used by the ticket management instruction set 136 on the game management server 148 when providing TITO functionality. In some embodiments, ticket identifiers from a pool of candidate ticket identifiers may be available for assignment to campaign ticket data 176 and to TITO data 184. Examples of the data fields that may be provided in the data structure 200 include, without limitation, the campaign identifier field 204, an entitlement identifier field 208, an entitlement validity period field 212, an entitlement status field 216, an entitlement amount field 220, an entitlement redeeming device identifier field 224, a ticket identifier field 228, a ticket validity period field 232, a ticket status field 236, a ticket redemption amount field 240, and a ticket redeeming device identifier field 244. It should be appreciated that the data structure 200 may have greater or fewer fields than depicted in FIG. 2A.

The campaign identifier field 204 may be used to store a unique number or alphanumeric string assigned to particular campaign. In some embodiments, the data stored in the campaign identifier field 204 may be randomly generated, pseudo-randomly generated, or sequentially generated based on when the campaign is created. In some embodiments, the identification number assigned to the campaign may be globally unique to the campaign among other active campaigns 248. While numeric values may be used for the campaign identifier field 204, it should be appreciated that any alphanumeric string may be used for the campaign identifier stored in the campaign identifier field 204.

The entitlement identifier field 208 may be used to store entitlement identifiers that have been assigned to the corresponding campaign. In some embodiments, the entitlement identifier value stored in the entitlement identifier field 208 may correspond to a GUID or UUID that uniquely identifies the entitlement from other entitlements among all active campaigns 248.

The entitlement validity period field 212 may be used to store information describing times during which an entitlement may be validly redeemed. Alternatively or additionally, the entitlement validity period field 212 may store information describing when an entitlement is no longer valid/redeemable. Alternatively or additionally, the entitlement validity period field 212 may store a timer or clock-generated value that automatically decrements at a predetermined rate such that when the time value reaches zero, the corresponding entitlement is no longer valid/redeemable.

The entitlement status field 216 may be used to store information indicating whether a particular entitlement is still active (e.g., still belonging to a valid campaign and not yet redeemed), whether an entitlement is redeemed, whether an entitlement is no longer redeemable, etc. In some embodiments, the entitlement status field 216 may include a bit that is flipped to indicate whether an associated entitlement is active and redeemable or inactive and not redeemable. The entitlement status field 216 may also be used to store date and/or time information describing when an entitlement is created, redeemed, and/or expired.

The entitlement amount field 220 may be used to store an entitlement value or any other information describing the value of the entitlement or a value to be assigned to a ticket when an entitlement is redeemed. Alternatively or additionally, the entitlement amount field 220 may be used to store information that can be used to compute an entitlement value, information that can be used to compute a corresponding ticket value, or the like.

The entitlement redeeming device identifier field 224 may be used to store information describing a device at which an entitlement is redeemed by a player 164. In some embodiments, a redeeming device identified in the entitlement redeeming device identifier field 224 may correspond to a gaming machine 108, wager terminal 112, and/or a mobile device 160. A player 164 may be allowed to redeem an entitlement at a gaming machine 108 or a wager terminal 112 by inserting a printed coupon 168 into a ticket acceptance device of the gaming machine 108 or wager terminal 112 (e.g., similar to a bill acceptor). Alternatively or additionally, a player 164 may present their mobile device 160 with an image of an entitlement thereon to a gaming machine 108 or wager terminal 112 to redeem the entitlement, rather than providing a physical ticket to the gaming machine 108 or wager terminal 112. Alternatively or additionally, a player 164 may be allowed to redeem an entitlement at a mobile device 160 by selecting a digital version of the entitlement stored on the mobile device 160 and indicating that the entitlement should be redeemed. This particular redemption model may require the mobile device 160 to interact with the game management server 148 and/or coupon campaign management server 116 to ensure that the entitlement being redeemed at the mobile device 160 is eligible for redemption. Thus, the entitlement redeeming device identifier field 224 may store information uniquely describing the device used by the player 164 to redeem an entitlement (e.g., an address or device ID). Alternatively or additionally, the entitlement redeeming device identifier field 224 may store information describing a type of device that was used for redemption (e.g., whether the device is a gaming machine 108, wager terminal 112, or a mobile device 160).

The data fields 208, 212, 216, 220, 224 may be considered part of the campaign entitlement data 172. Accordingly, a number of entitlements and their associated campaign entitlement data 172 may be stored in the data structure 200 with an association to a particular campaign identifier field 204 and, if still active, with an association to active campaigns 248. The ticket identifier field 228, ticket validity period field 232, ticket status field 236, ticket redemption amount field 240, and ticket redeeming device identifier field 244 may correspond to data fields belonging to the campaign ticket data 176.

The ticket identifier field 228 may be used to store ticket identifiers that have been assigned to tickets. When a ticket is issued by the coupon campaign management server 116 in response to an entitlement redemption, then the ticket may correspond to a redeemable coupon ticket with a ticket identifier printed thereon and/or encoded thereon with a barcode, QR code, or the like. When a ticket is issued by the game management server 148 as a TITO ticket, then the TITO ticket may also have a ticket identifier printed thereon and/or encoded thereon with a barcode, QR code, or the like. The TITO ticket may be different from the redeemable coupon ticket in its genesis (e.g., the TITO ticket is issued in response to a cashout event at a gaming machine 108 or wager terminal 112 whereas a coupon ticket is issued in response to an entitlement redemption event), but the tickets are generally capable of providing similar benefits to a player 164. For instance, both tickets may be redeemable for cash value, credit at a gaming machine 108, wager terminal 112, or mobile communication device 160 for use in gameplay, or the like. In some embodiments, the ticket identifier value stored in the ticket identifier field 208 may correspond to a GUID or UUID that uniquely identifies the ticket (whether TITO ticket or coupon ticket) from other tickets among all active campaigns 248 and/or among other TITO tickets. The format of the ticket identifier value stored in the ticket identifier field 228 may be similar to the format of the entitlement identifier value stored in the entitlement identifier field 208.

The ticket validity period field 232 may be used to store information describing times during which a ticket may be validly redeemed. In some embodiments, a ticket's validity period may be determined, at least in part, based on a validity period of the entitlement that was redeemed and resulted in the generation of the ticket. In some embodiments, the ticket validity period may be coincident (e.g., overlap) with the entitlement validity period. In some embodiments, at least some of the ticket validity period may not overlap with the entitlement validity period. For instance, the ticket validity period may not begin until the point in time that an entitlement is redeemed and the ticket validity period may expire after a time at which the redeemed entitlement was set to expire. As a non-limiting example, a ticket validity period may be represented as an amount of time after which the entitlement was redeemed (e.g., ticket is valid for one week after entitlement redemption). In situations where the ticket validity period is determined based on the entitlement state and/or entitlement validity period, there may be a reference from the ticket validity period field 232 to the entitlement validity period field 212 and/or entitlement status field 216. Alternatively or additionally, the ticket validity period field 232 may store information describing when a ticket is no longer valid/redeemable. Alternatively or additionally, the ticket validity period field 232 may store a timer or clock-generated value that automatically decrements at a predetermined rate such that when the time value reaches zero, the corresponding ticket is no longer valid/redeemable.

The ticket status field 236 may be used to store information indicating whether a particular ticket is still active (e.g., still belonging to a valid campaign and not yet redeemed), whether a ticket is redeemed, whether a ticket is no longer redeemable, etc. In some embodiments, the ticket status field 236 may include a bit that is flipped to indicate whether an associated ticket is active and redeemable or inactive and not redeemable. The ticket status field 236 may also be used to store date and/or time information describing when a ticket is created, redeemed, and/or expired.

The ticket redemption amount field 240 may be used to store a ticket monetary value or any other information describing the value of the ticket when a ticket is redeemed. Alternatively or additionally, the ticket redemption amount field 240 may be used to store information that can be used to compute a ticket value, which may or may not depend upon the value(s) stored in the entitlement amount field 220.

The ticket redeeming device identifier field 244 may be used to store information describing a device that was used by a player 164 to redeem a ticket. The device identified in the ticket redeeming device identifier field 244 may correspond to a gaming machine 108, wager terminal 112, and/or a mobile device 160. A player 164 may be allowed to redeem a ticket in a similar fashion to the way in which an entitlement is redeemed. In some embodiments, the player 164 may redeem the ticket at the same device that was used by the player 164 to redeem the entitlement. In other embodiments, the player 164 may be required to redeem a ticket at a different device than was used to redeem the entitlement. Such redemption rules or requirements may be stored with the campaign ticket data 176, possibly within the ticket status field 236.

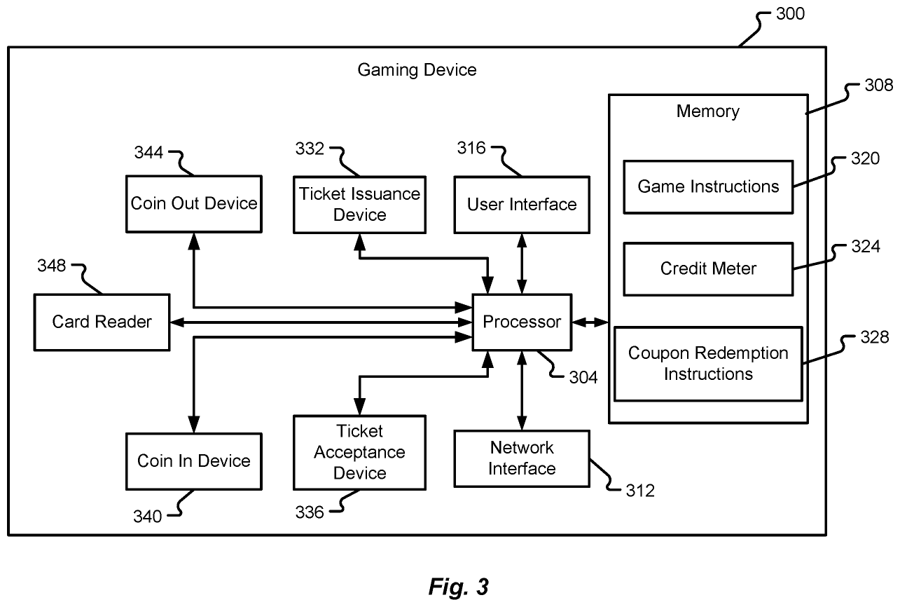

With reference now to FIG. 3, additional details of a gaming device 300 will be described in accordance with at least some embodiments of the present disclosure. It should be appreciated that a gaming device 300 may correspond to a gaming machine 108, a wager terminal 112, a mobile device 160, a combination thereof, or any other device that facilitates user interaction with a game or enables wager activity as described herein.

The gaming device 300 is depicted to include a processor 304, memory 308, a network interface 312, a user interface 316, a ticket issuance device 332, a ticket acceptance device 336, a coin in device 340, a coin out device 344, and a card reader 348. In some embodiments, the processor 304 may be similar or identical to the processor 120. In other words, the processor 304 may correspond to one or many microprocessors, CPUs, microcontrollers, or the like. The processor 304 may be configured to execute one or more instruction sets stored in memory 308.

The network interface 312 may also be similar or identical to network interface 128. The nature of the network interface 312, however, may depend upon whether the network interface 312 is provided in a gaming machine 108 or a mobile user device 160. Examples of a suitable network interface 312 include, without limitation, an Ethernet port, a USB port, an RS-232 port, an RS-485 port, a NIC, an antenna, a Slot Machine Interface Board (SMIB), a driver circuit, a modulator/demodulator, etc. The network interface 312 may include one or multiple different network interfaces depending upon whether the gaming device 300 is connecting to a single communication network 104 or multiple different types of communication networks 104. For instance, the gaming device 300 may be provided with both a wired network interface and a wireless network interface without departing from the scope of the present disclosure.

The user interface 316 may correspond to any type of input and/or output device that enables the player 164 to interact with the gaming device 300. As can be appreciated, the nature of the user interface 316 may depend upon the nature of the gaming machine 108. For instance, if the gaming device 300 is a traditional mechanical reel slot machine, then the user interface 316 may include one or more mechanical reels with symbols provided thereon, one or more lights or LED displays, one or more depressible buttons, a lever or “one armed bandit handle”, a speaker, or combinations thereof. If the gaming device 300 is a digital device, then the user interface 316 may include one or more touch-sensitive displays, LED/LCD display screens, etc.

The memory 308 may be similar or identical to memory 124. For instance, the memory 308 may include one or multiple computer memory devices that are volatile or non-volatile. The memory 308 may be configured to store instruction sets that enable player 164 interaction with the gaming device 300, that enable game play at the gaming device 300, that enable wagering at the gaming device 300, and/or that enable coordination with the coupon campaign management server 116 and/or game management server 148. Examples of instruction sets that may be stored in the memory 308 include a game instruction set 320, a credit meter 324, and a coupon redemption instruction set 328. The coupon redemption instruction set 328 may be invoked when a player 164 is redeeming an entitlement and/or a ticket. In some embodiments, the coupon redemption instruction set 328 may include functionality described in connection with the entitlement management instruction set 132 and/or ticket management instruction set 136, thereby facilitating the gaming device 300 to locally accept entitlement and/or ticket redemptions. Alternatively or additionally, the coupon redemption instruction set 328 may be configured to enable communications between the gaming device 300 and the coupon campaign management server 116. In such a scenario, the coupon redemption instruction set 328 may be configured to provide the coupon campaign management server 116 with appropriate entitlement and/or ticket information that is used during redemption of the entitlement and/or ticket.

In some embodiments, the game instructions 320, when executed by the processor 304, may enable the gaming device 300 to facilitate one or more games of chance, one or more games of skill, and/or one or more hybrid games of chance/skill and produce interactions between the player 164 and the game of chance and/or skill. In some embodiments, the game instructions 320 may include subroutines that present one or more graphics to the player 164 via the user interface 316, subroutines that calculate whether a particular wager has resulted in a win or loss during the game of chance or skill, subroutines for determining payouts for the player 164 in the event of a win, subroutines for exchanging communications with a connected server (e.g., game management server, coupon campaign management server 116, or the like), subroutines for enabling the player 164 to engage in a game using their mobile user device 160, and any other subroutine or set of instructions that facilitate gameplay at or in association with the gaming device 300. Alternatively or additionally, depending upon the nature of the gaming device 300 (or if implemented in a wager terminal 112), the game instruction set 320 may enable a player 164 to place wagers on events, track event progress, track event outcomes, organize tickets associated with wagered events, report outcomes of wagered events, report win amounts for tickets associated with game outcomes, and the like. In some embodiments, the game instruction set 320 may also provide the player 164 with the ability to view, in real-time, events that have been the subject of a wager.

The credit meter 324 may correspond to a secure instruction set and/or data structure within the gaming device 300 that facilitates a tracking of wager activity at the gaming device 300. In some embodiments, the credit meter 324 may be used to store or log information related to various player 164 activities and events that occur at the gaming device 300. The types of information that may be maintained in the credit meter 324 include, without limitation, player information, available credit information, wager amount information, and other types of information that may or may not need to be recorded for purposes of accounting for wagers placed at the gaming device 300 and payouts made for a player 164. In some embodiments, the credit meter 324 may be configured to track coin in activity, coin out activity, coin drop activity, jackpot paid activity, bonus paid activity, credits applied activity, external bonus payout activity, ticket in activity, ticket out activity, timing of events that occur at the gaming device 300, and the like. In some embodiments, certain portions of the credit meter 324 may be updated in response to outcomes of a game of chance or skill played at the gaming device 300. In some embodiments, the credit meter 324 may be updated depending upon whether the gaming device 300 is printing a ticket in response to an entitlement redemption, being used as a point of redemption for an entitlement and/or ticket, and/or any other activity associated with an entitlement or ticket. Some or all of the data within the credit meter 324 may be reported to the coupon campaign management server 116 or game management server 148, for example, if such data applies to a centrally-managed game and/or a status of an entitlement or ticket.

Because the gaming device 300 may be used for the acceptance of entitlements and tickets and for the issuance of tickets, the gaming device 300 may be provided with appropriate hardware to facilitate such acceptance and issuance. Specifically, the gaming device 300 may be provided with a ticket acceptance device 336 that is configured to accept or scan physically-printed coupons 168 and extract appropriate information therefrom. In some embodiments, the ticket acceptance device 336 may include one or more machine vision devices (e.g., a camera, IR scanner, optical scanner, barcode scanner, etc.), a physical ticket acceptor, a shredder, etc. The ticket acceptance device 336 may be configured to accept physical entitlements/tickets and/or electronic entitlements/tickets without departing from the scope of the present disclosure. An electronic entitlement or ticket may be accepted by scanning a one-dimensional barcode, two-dimensional barcode, or other type of barcode or quick response (QR) code displayed by a player's 164 mobile device 160, for example. In addition to enabling machine acceptance of entitlements and tickets, the ticket acceptance device 336 may also be configured to accept other physical pieces of paper (e.g., paper currency, bills, receipts, etc.).

The ticket issuance device 332 may be configured to print or provide physical tickets or vouchers to players 112. In some embodiments, the ticket issuance device 332 may be configured to issue a ticket consistent with an amount of credit available to a player 164, possibly as indicated within the credit meter 324. In some embodiments, the ticket issuance device 332 may be configured to issue a ticket consistent with an entitlement that was redeemed at the gaming device 300. In addition to enabling machine interaction or provisioning of tickets, the ticket issuance device 332 may also be configured to deliver physical pieces of paper (e.g., paper currency, bills, receipts, etc.) to a player 164.

The coin in device 340 may include a coin acceptor, a chip acceptor or reader, a token acceptor, or the like. The coin out device 344, like the ticket issuance device 322, may operate and issue real currency or playing currency in the form of coins, tokens, or chips based on an amount indicated within the credit meter 324. In some embodiments, the coin out device 344 may include a coin tray or the like and counting hardware configured to count and distribute an appropriate amount of coins or tokens based on a player's 164 winnings or available credit within the credit meter 324.

Although not depicted, the gaming device 300 may also include an instruction set that enables and manages communications and interactions with a mobile device 160. In some embodiments, a set of communication instructions may be provided in memory 308 to enable the gaming machine 108 to pair with a mobile device 160 and exchange information with the mobile device 160 using a proximity-based communication channel.

The card reader 348 may include hardware and/or software configured to read or accept any type of card or portable credential. In some embodiments, the card reader 348 may include hardware and/or software that enable contactless reading of a card or portable credential (e.g., NFC, Bluetooth, Wifi, etc.). In some embodiments, the card reader 348 may include hardware and/or software that enables contact-based reading of a card or portable credential (e.g., magstripe, chip reader, electrodes, card-receiving slot, etc.). It should be appreciated that the card reader 348 may be configured to receive and read a card or portable credential in any type of format (e.g., portable plastic card, magstripe card, key fob, etc.). It should also be appreciated that the card reader 348 may be configured to write information or data onto a card or portable credential. Furthermore, in some embodiments, the card reader 348 may be configured to read a player loyalty card in the form of a plastic credit-card shaped credential. In some embodiments, the card reader 348 may be enable communications with a loyalty application operating on a user's mobile device 160.

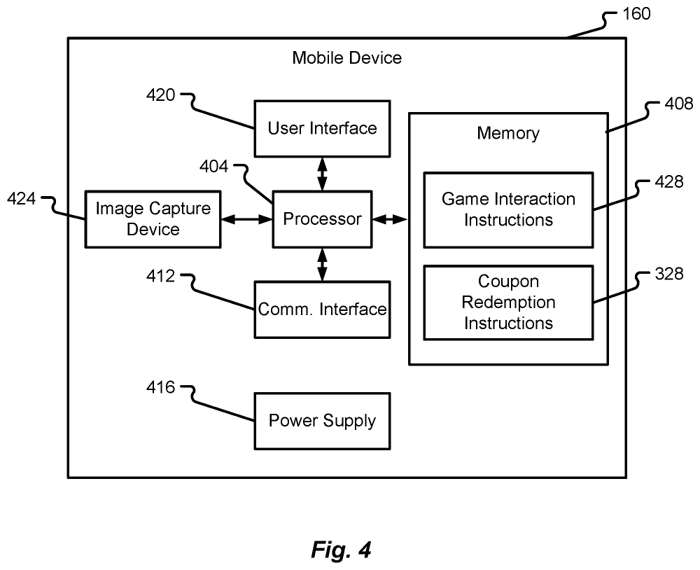

With reference now to FIG. 4, additional details of the components that may be included in a mobile device 160 will be described in accordance with at least some embodiments of the present disclosure. The mobile device 160, being one specific but non-limiting example of a gaming device 300, is shown to include a processor 404, memory 408, a communication interface 412, a user interface 420, and an image capture device 424. In some embodiments, the processor 404 may be similar or identical to any of the other processors 120, 308 depicted and described herein and may correspond to one or many microprocessors, CPUs, microcontrollers, Integrated Circuit (IC) chips, or the like. The processor 404 may be configured to execute one or more instruction sets stored in memory 408. In some embodiments, the instruction sets stored in memory 408, when executed by the processor 404, may enable the mobile device 160 to provide game play functionality, interact with gaming machines 108, pair with gaming machines 108, interact with wager terminals 112, pair with wager terminals 112, manage digital tickets, track wager activity associated with digital tickets, or any other type of desired functionality.

The communication interface 412 may be similar or identical to the network interfaces 128, 312 depicted and described herein. The nature of the communication interface 412 may depend upon the type of communication network 108 for which the mobile device 160 is configured. Examples of a suitable communication interfaces 412 include, without limitation, a WiFi antenna and driver circuit, a Bluetooth antenna and driver circuit, a cellular communication antenna and driver circuit, a modulator/demodulator, etc. The communication interface 412 may include one or multiple different network interfaces depending upon whether the mobile device 160 is connecting to a single communication network 104 or multiple different types of communication networks. For instance, the mobile device 160 may be provided with both a wired communication interface 412 and a wireless communication interface 412 without departing from the scope of the present disclosure.

The user interface 420 may include a combination of a user input and user output device. For instance, the user interface 420 may include a display device, a microphone, a speaker, a haptic feedback device, a light, a touch-sensitive display, a button, or a combination thereof. The user interface 420 may also include one or more drivers for the various hardware components that enable user interaction with the mobile device 160.

The memory 408 may be similar or identical to other memory 124, 308 depicted and described herein and may include one or multiple computer memory devices that are volatile or non-volatile. The memory 408 may be configured to store instruction sets that enable player interaction with the mobile device 160 and that enable game play at the mobile device 160. An illustrative instruction set that may be included in memory 408 is a game interaction instruction set 428. In some embodiments, the game interaction instruction set 428 may enable the mobile device 160 to communicate with a game executed by a gaming machine 108 and may also include instructions that allow the mobile device 160 to interact with a wager terminal 112 for purposes of placing a wager on an event.

The coupon redemption instruction set 328 may be similar or identical to the instruction set shown and described in connection with the gaming device 300. The coupon redemption instruction set 328 executed by the mobile device 160 may enable a player 164 to redeem an entitlement and/or ticket using a mobile device 160 rather than requiring the player 164 to redeem the entitlement and/or ticket at a gaming machine 108 or wager terminal 112.

The image capture device 424 may correspond to one or multiple devices and drivers for capturing an image of a physical object (e.g., a physical printed coupon). The coupon redemption instruction set 328 may then be used to decode the image(s) captured by the image capture device 424 to extract any necessary image for purposes of entitlement or ticket redemption. For instance, the coupon redemption instruction set 328 may extract an entitlement identifier, an entitlement amount, a ticket identifier, a ticket amount, or any other information encoded, printed, or otherwise represented on an object. The image capture device 124 may include a camera, lens, shutter, set of image pickup elements, or any other hardware or software component used to collect light and transform the collected light into digital image data (e.g., pixel data).

Although not shown, the memory 408 may also include a communication instruction set that, when executed by the processor 404, enables the mobile device 160 to communicate via the communication network 104. In some embodiments, the communication instruction set may be particular to the type of communication network 104 used by the mobile device 160. As an example, the communication instruction set on the mobile device 160 may be configured to enable cellular, WiFi, and/or Bluetooth communications with other devices. The communication instruction set may follow predefined communication protocols and, in some embodiments, may enable the mobile device to remain paired with a gaming machine 108 or wager terminal 112 as long as the mobile device 160 is within a predetermined proximity (e.g., 20-30 feet, an NFC communication range, or a Bluetooth communication range).

The mobile device 160 is also shown to include a power supply 416. The power supply 416 may correspond to an internal power supply that provides AC and/or DC power to components of the mobile device 160. In some embodiments, the power supply 416 may correspond to one or multiple batteries. Alternatively or additionally, the power supply 416 may include a power adapter that converts AC power into DC power for direct application to components of the mobile device 160, for charging a battery, for charging a capacitor, or a combination thereof.

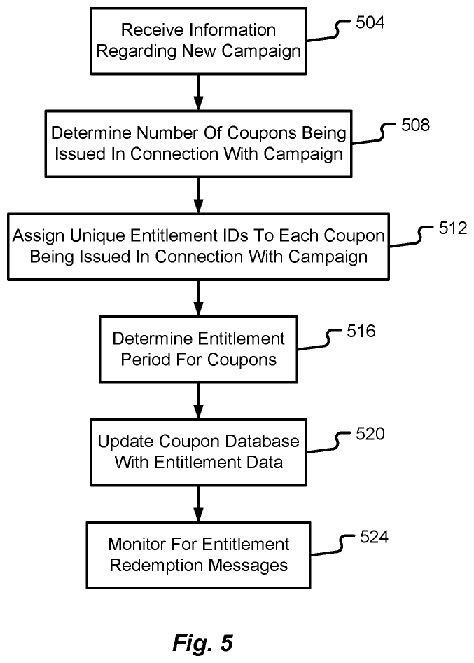

With reference now to FIGS. 5-7, various methods of operating components of a system 100 will be described herein. It should be appreciated that any of the methods or the method steps depicted and described herein can be performed by any device depicted and described herein and may be performed in an order other than the order depicted. Moreover, steps from one method may be performed in another method without departing from the scope of the present disclosure.

With reference initially to FIG. 5, a first method will be described in accordance with at least some embodiments of the present disclosure. The method begins with the coupon campaign management server 116 receiving information regarding a new promotional campaign to be executed (step 504). This information may include a number of entitlements to issue and other information related to the launching of the new campaign.

The method continues with the determining a number of coupons 168 that will be issued in connection with the campaign (step 508). In some embodiments, the number of coupons 168 may correspond to the number of entitlements that will eventually be generated for the campaign. The method then continues with the entitlement management instruction set 132 assigning unique entitlement identifiers to each coupon 168 being issued in connection with the campaign (step 512). In some embodiments, the entitlement identifiers assigned to the coupons 168 may be taken from a pool of entitlement identifiers and may be in the form of a GUID, UUID, or the like. Each entitlement identifier assigned to each coupon 168 should be configured to uniquely identify the coupon 168 from all other coupons 168 in the campaign. This unique assignment of entitlement identifiers may help to determine campaign statistics after the campaign has ended. The types of campaign statistics that may be useful to track or determine after a campaign has ended (or during an active campaign) may include entitlement redemption statistics (e.g., number of entitlements redeemed, time of entitlement redemption, location of entitlement redemption, average entitlement redemption amount, number of tickets issued based on entitlement redemptions, number of tickets redeemed, time or ticket redemption, location of ticket redemption, revenue generated in response to ticket or entitlement redemption, etc.).

The method may then continue by determining an entitlement period for the coupons 168 to be issued in connection with the campaign (step 516). All coupons 168 associated with a particular campaign may be assigned the same entitlement validity period. In other embodiments, certain entitlements may be assigned different entitlement validity periods, perhaps based on the intended recipient of the entitlement, the entitlement value, or the like. Based on the entitlement identifiers used for the coupons 168 and the entitlement period(s) determined for the entitlements, the entitlement management instruction set 132 works in cooperation with the database management instruction set 140 to update the database 144 with the campaign entitlement data 172 for the newly-launched campaign (step 520). The method will then continue with the coupon campaign management server 116 monitoring the system 100 for entitlement redemption messages issued in response to a player 164 redeeming an entitlement (step 524). In some embodiments, the campaign entitlement data 172 may continue to be updated based on redemption activity and/or expiration of entitlement validity periods. Such management of the database 144 may be achieved with the cooperative execution of the entitlement management instruction set 132 and database management instruction set 140.

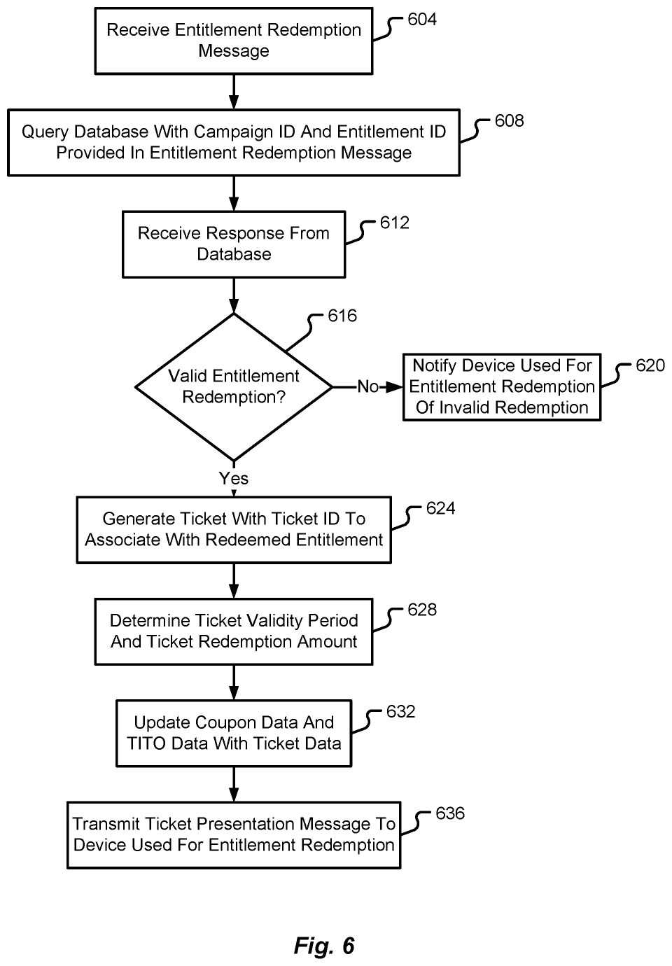

With reference now to FIG. 6, a second method will be described in accordance with at least some embodiments of the present disclosure. The method begins when an entitlement redemption message is received at the coupon campaign management server 116 (step 604). The entitlement redemption message may be received via the communication network 104 from a device at which a player 164 is redeeming an entitlement. The redemption may be facilitated with assistance from authorized personnel of an enterprise running the campaign (e.g., a casino) or may be facilitated entirely by the player 164.

The method continues with the entitlement management instruction set 132 extracting a campaign identifier, an entitlement identifier, a time at which the coupon 168 was presented to the device (e.g., a timestamp), and any other entitlement information from the entitlement redemption message. The extracted information may then be provided by the entitlement management instruction set 132 to the database management instruction set 140, which generates a database query that includes the campaign identifier, entitlement identifier, and any other relevant query information (step 608). The query is then used by the database management instruction set 140 to retrieve desired information from the database 144 (step 612).

The information received from the database 144 in response to the query may include an indication that the campaign identifier and entitlement identifier are associated with a valid/active campaign. The response may also include an identification of an entitlement validity period and an entitlement amount that are associated with the entitlement identifier provided in the query. The information received from the database 144 may then be provided back to the entitlement management instruction set 132, which determines whether or not the entitlement being redeemed is actually associated with a valid entitlement identifier, a valid campaign identifier, and is within the entitlement validity period (step 616). If any of these considerations are not met, then the entitlement management instruction set 132 may determine that the entitlement redemption attempt was invalid and may notify the device used for the entitlement redemption of the invalid redemption attempt (step 620). The notification provided back to the device used for the entitlement redemption may include a reason for determining the redemption is invalid or may include an error message. The notification may alternatively or additionally include instructions for correcting the problem associated with the redemption attempt.

If, however, the entitlement redemption is determined to be valid, then the method continues with the entitlement management instruction set 132 invoking the ticket management instruction set 136 to generate a valid ticket (step 624) with a ticket identifier, ticket redemption value, and ticket validity period (step 628). The ticket identifier may be generated only in response to receiving the confirmation of a valid entitlement redemption. The ticket identifier may uniquely identify the generated ticket from among other tickets used for the campaign or any other active campaign 248. The ticket validity period may be determined, at least in part, based on the entitlement validity period. The ticket redemption amount may be determined, at least in part, based on the entitlement amount. In some embodiments, the ticket validity period may not start until after the entitlement validity period ends. In some embodiments, the ticket validity period may end at the same time that the entitlement validity period ends. In some embodiments, the ticket validity period may end at some time after the entitlement validity period ends.

The method will then continue with the ticket management instruction set 136 working in cooperation with the database management instruction set 140 to update the campaign ticket data 176 in the database 144 (step 632). The method may then continue with the ticket management instruction set 136 transmitting a ticket presentation message to the device used for the entitlement redemption (step 636). The method may also include informing the game management server 148 of the redeemed entitlement and the newly-generated ticket. The game management server 148 may respond to such a notification by instructing the device used for the entitlement redemption to print or issue a ticket to the player 164 in accordance with the ticket information provided to the game management server 148 by the coupon campaign management server 116.

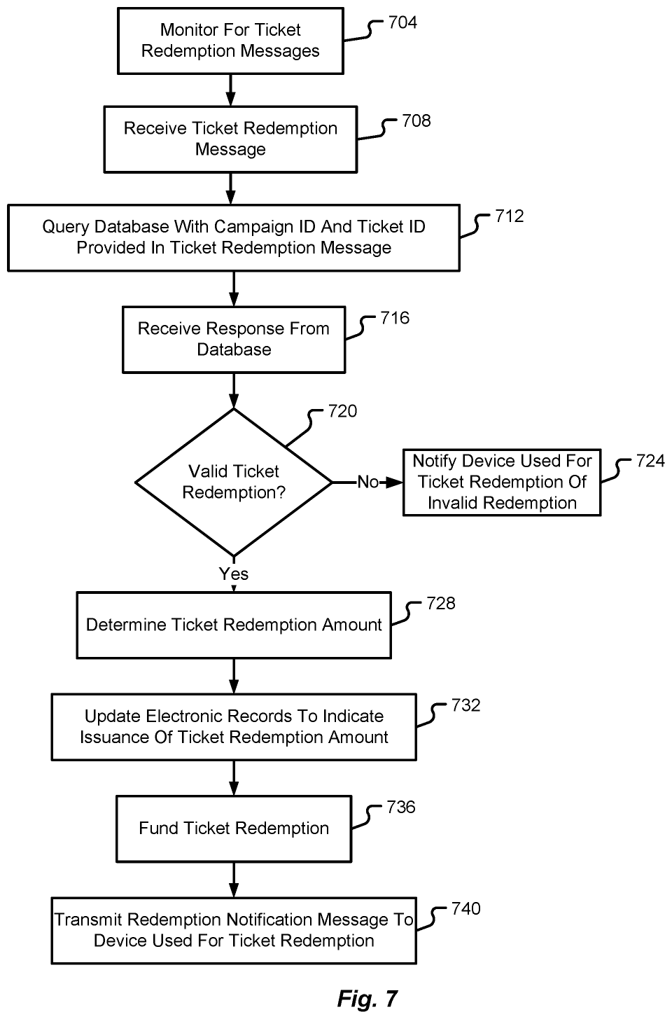

With reference now to FIG. 7, a third method will be described in accordance with at least some embodiments of the present disclosure. The method begins with the coupon campaign management server 116 monitoring the system 100 for ticket redemption messages (step 704). The method then continues when a ticket redemption message is received at the coupon campaign management server 116 (step 708). The ticket management instruction set 136 may then extract a campaign identifier, a ticket identifier, ticket redemption value, and/or a timestamp associated with a time at which the ticket was presented to the device being used for ticket redemption.

The information extracted from the ticket redemption message may then be provided to the database management instruction set 140, which generates a database query that includes the campaign identifier, the ticket identifier, and any other relevant query information (step 712). The query is then used by the database management instruction set 140 to retrieve desired information from the database 144 (step 716).

The information received from the database 144 is then provided back to the ticket management instruction set 136, thereby enabling the ticket management instruction set 136 to determine whether the ticket redemption is valid or not (step 720). In some embodiments, the ticket management instruction set 136 may determine whether the campaign identifier and ticket identifier were associated with a valid and active campaign. The ticket management instruction set 136 may also determine if the redemption of the ticket occurred within the ticket validity period. If these criteria are not satisfied, then the ticket redemption may be determined to be invalid and the device used for the ticket redemption may be notified of the invalid redemption (step 724). This may cause the device to present an appropriate message to the player 164 indicating that the ticket redemption is invalid along with reasons for the failed redemption.

On the other hand, if the ticket redemption is determined to be valid, then the method may continue with the ticket management instruction set 136 determining the ticket redemption amount (step 728) and updating the appropriate electronic records in the campaign ticket data 176 to indicate the issuance of the ticket redemption amount (step 732). The ticket management instruction set 136 may also notify the game management server 148 of the ticket redemption and ticket redemption amount, thereby causing the game management server 148 to fund the ticket redemption from an appropriate account in the system (step 736). For instance, the ticket redemption may be funded by a campaign account, marketing account, or some other account within a casino system. Funding of the ticket redemption amount may also include instructing the device at which the ticket redemption occurred to update its credit meter 324 by the ticket redemption amount and/or causing the device at which the ticket redemption occurred to print or issue a voucher that can be redeemed for cash at a casino cage. Alternatively or additionally, the method may also include transmitting a redemption notification message back to the device used for the ticket redemption (step 740). This message may be transmitted by the coupon campaign management server 116 or the game management server 148. The message may include information describing the redeemed ticket, a value of the redeemed ticket, and any other action taken in connection with the ticket redemption.

The present disclosure contemplates a variety of different systems each having one or more of a plurality of different features, attributes, or characteristics. A “system”, “gaming system”, or “promotional system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an Electronic Gaming Machine (EGM) as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk.

In various embodiments, the system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts. A “gaming device” as used herein may be understood to include an EGM, multiple EGMs, a personal gaming device, multiple personal gaming devices, a mobile device, multiple mobile devices, a wager terminal, multiple wager terminals, or combinations thereof.

As noted above, in various embodiments, the system includes a gaming device in combination with a central server, central controller, or remote host. In such embodiments, the EGM (or gaming device) is configured to communicate with the central server, central controller, or remote host through a data network or remote communication link. In certain such embodiments, the EGM (or gaming device) is configured to communicate with another EGM (or gaming device) through the same data network or remote communication link or through a different data network or remote communication link. For example, the system includes a plurality of gaming devices that are each configured to communicate with a central server, central controller, or remote host through a data network.

In certain embodiments in which the system includes a gaming device in combination with a central server, central controller, or remote host, the central server, central controller, or remote host is any suitable computing device (such as a server) that includes at least one processor and at least one memory device or data storage device. As further described herein, the EGM (or gaming device) includes at least one EGM (or gaming device) processor configured to transmit and receive data or signals representing events, messages, commands, or any other suitable information between the EGM (or gaming device) and the central server, central controller, or remote host. The at least one processor of that EGM (or gaming device) is configured to execute the events, messages, or commands represented by such data or signals in conjunction with the operation of the EGM (or gaming device). Moreover, the at least one processor of the central server, central controller, or remote host is configured to transmit and receive data or signals representing events, messages, commands, or any other suitable information between the central server, central controller, or remote host and the EGM (or gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or gaming device). Further, one, more than one, or each of the functions of the at least one processor of the EGM (or gaming device) may be performed by the at least one processor of the central server, central controller, or remote host.

In certain such embodiments, computerized instructions for controlling any games (such as any primary or base games and/or any secondary or bonus games) displayed by the EGM (or gaming device) are executed by the central server, central controller, or remote host. In such “thin client” embodiments, the central server, central controller, or remote host remotely controls any games (or other suitable interfaces) displayed by the EGM (or gaming device), and the EGM (or gaming device) is utilized to display such games (or suitable interfaces) and to receive one or more inputs or commands. In other such embodiments, computerized instructions for controlling any games displayed by the EGM (or gaming device) are communicated from the central server, central controller, or remote host to the EGM (or gaming device) and are stored in at least one memory device of the EGM (or gaming device). In such “thick client” embodiments, the at least one processor of the EGM (or gaming device) executes the computerized instructions to control any games (or other suitable interfaces) displayed by the EGM (or gaming device).

In various embodiments in which the system includes a plurality of EGMs (or gaming devices), one or more of the EGMs (or gaming devices) are thin client EGMs (or gaming devices) and one or more of the EGMs (or gaming devices) are thick client EGMs (or gaming devices). In other embodiments in which the system includes one or more EGMs (or gaming devices), certain functions of one or more of the EGMs (or gaming devices) are implemented in a thin client environment, and certain other functions of one or more of the EGMs (or gaming devices) are implemented in a thick client environment. In one such embodiment in which the system includes an EGM (or gaming device) and a central server, central controller, or remote host, computerized instructions for controlling any primary or base games displayed by the EGM (or gaming device) are communicated from the central server, central controller, or remote host to the EGM (or gaming device) in a thick client configuration, and computerized instructions for controlling any secondary or bonus games or other functions displayed by the EGM (or gaming device) are executed by the central server, central controller, or remote host in a thin client configuration.

In certain embodiments in which the system includes: (a) an EGM (or gaming device) configured to communicate with a central server, central controller, or remote host through a data network; and/or (b) a plurality of EGMs (or gaming devices) configured to communicate with one another through a communication network, the communication network may include a local area network (LAN) in which the EGMs (or gaming devices) are located substantially proximate to one another and/or the central server, central controller, or remote host. In one example, the EGMs (or gaming devices) and the central server, central controller, or remote host are located in a gaming establishment or a portion of a gaming establishment.

In other embodiments in which the system includes: (a) an EGM (or gaming device) configured to communicate with a central server, central controller, or remote host through a data network; and/or (b) a plurality of EGMs (or gaming devices) configured to communicate with one another through a communication network, the communication network may include a wide area network (WAN) in which one or more of the EGMs (or gaming devices) are not necessarily located substantially proximate to another one of the EGMs (or gaming devices) and/or the central server, central controller, or remote host. For example, one or more of the EGMs (or gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or gaming devices) are located. In certain embodiments in which the communication network includes a WAN, the system includes a central server, central controller, or remote host and an EGM (or gaming device) each located in a different gaming establishment in a same geographic area, such as a same city or a same state. Systems in which the communication network includes a WAN are substantially identical to systems in which the communication network includes a LAN, though the quantity of EGMs (or gaming devices) in such systems may vary relative to one another.

In further embodiments in which the system includes: (a) an EGM (or gaming device) configured to communicate with a central server, central controller, or remote host through a data network; and/or (b) a plurality of EGMs (or gaming devices) configured to communicate with one another through a communication network, the communication network may include an internet (such as the Internet) or an intranet. In certain such embodiments, an Internet browser of the EGM (or gaming device) is usable to access an Internet game page from any location where an Internet connection is available. In one such embodiment, after the EGM (or gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or gaming device). Examples of implementations of Internet-based gaming are further described in U.S. Pat. No. 8,764,566, entitled “Internet Remote Game Server,” and U.S. Pat. No. 8,147,334, entitled “Universal Game Server”.

The central server, central controller, or remote host and the EGM (or gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

Embodiments of the present disclosure will be described in connection with a system having one or multiple user devices that enable gaming activity. While certain embodiments of the present disclosure will reference the use of gaming device, which may include an Electronic Gaming Machine (EGM), a Video Gaming Machine (VGM), a wager terminal, and/or a mobile device as a device that enables users to participate in wagering activity, it should be appreciated that embodiments of the present disclosure are not so limited. For instance, any computing device, personal gaming machine, or collection of computing devices may be used as a gaming device to facilitate player engagement with a wagering server.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The invention is claimed as follows:

1. A method, comprising:
receiving, at a server, an entitlement redemption message from a communication device, wherein the entitlement redemption message comprises a campaign identifier and an entitlement identifier;
determining, at the server, that the campaign identifier and the entitlement identifier belong to a valid campaign;
generating, at the server and in response to determining that the campaign identifier and the entitlement identifier belong to a valid campaign, an electronic record for a ticket with a redeemable status, wherein the electronic record for the ticket is associated with the entitlement identifier and comprises a ticket validity period and a ticket redemption amount; and
transmitting, from the server, a ticket presentation message that comprises an indication of the ticket validity period and the ticket redemption amount.

2. The method of claim 1, wherein determining that the campaign identifier and the entitlement identifier belong to a valid campaign comprises:
generating, at the server, a database query that includes the campaign identifier and the entitlement identifier;
transmitting the database query to a database that comprises electronic records associated with valid campaigns; and
receiving, at the server and from the database, a response to the database query that comprises an indication of the campaign identifier and entitlement identifier being associated with the valid campaign, wherein the response further comprises an identification of an entitlement validity period and an entitlement amount associated with the entitlement identifier.

3. The method of claim 2, wherein the ticket validity period is determined, at least in part, based on the entitlement validity period.

4. The method of claim 3, wherein the ticket validity period is different from the entitlement validity period, wherein the electronic record for the ticket further comprises a ticket identifier, and wherein the entitlement identifier is different from the ticket identifier.

5. The method of claim 3, wherein the entitlement identifier comprises a globally unique identifier (GUID), wherein the ticket redemption amount is determined, at least in part, based on the entitlement amount.

6. The method of claim 5, further comprising:
updating, with the server, an electronic record associated with the entitlement identifier to indicate that the entitlement identifier is redeemed.

7. The method of claim 3, further comprising:
receiving, at the server, a ticket redemption message comprising a ticket identifier;
determining that a time at which the ticket redemption message is received is within the ticket validity period; and
in response to determining that the time at which the ticket redemption message is received is within the ticket validity period, updating, with the server, the electronic record for the ticket to indicate the ticket redemption amount has been issued from an account associated with the valid campaign.

8. The method of claim 7, wherein the time at which the ticket redemption message is received is outside the entitlement validity period.

9. A server, comprising:
a processor; and
a computer-readable storage medium coupled with the processor and comprising instructions that are executable by the processor, wherein the instructions comprise:
a set of instructions that receive an entitlement redemption message comprising a campaign identifier and an entitlement identifier;
a set of instructions that determine the campaign identifier and entitlement identifier belong to a valid campaign;
a set of instructions that generate, in response to determining that the campaign identifier and entitlement identifier belong to a valid campaign, an electronic record for a ticket with a redeemable status, wherein the electronic record for the ticket is associated with the entitlement identifier and comprises a ticket validity period; and
a set of instructions that cause a ticket presentation message to be transmitted to a communication device, wherein the ticket presentation message comprises an indication of the ticket validity period.

10. The server of claim 9, wherein the electronic record for the ticket further comprises a ticket redemption amount and wherein the instructions further comprise:
a set of instructions that generate a database query that includes the campaign identifier and the entitlement identifier;
a set of instructions that transmit the database query to a database that comprises electronic records associated with valid campaigns; and
a set of instructions that receive a response to the database query that comprises an indication of the campaign identifier and entitlement identifier being associated with the valid campaign, wherein the response further comprises an identification of an entitlement validity period and an entitlement amount associated with the entitlement identifier.

11. The server of claim 10, wherein the ticket validity period expires after the entitlement validity period, wherein the entitlement identifier comprises a globally unique identifier (GUID), and wherein the ticket redemption amount is determined, at least in part, based on the entitlement amount.

12. The server of claim 10, wherein the instructions further comprise:
a set of instructions that update an electronic record associated with the entitlement identifier to indicate that the entitlement identifier is redeemed.

13. The server of claim 10, wherein the instructions further comprise:
a set of instructions that receive a ticket redemption message comprising the ticket identifier;
a set of instructions that determine a time at which the ticket redemption message is received is within the ticket validity period; and
a set of instructions that update, in response to determining that the time at which the ticket redemption message is received is within the ticket validity period, the electronic record for the ticket to indicate the ticket redemption amount has been issued from an account associated with the valid campaign.

14. The server of claim 13, wherein the time at which the ticket redemption message is received is outside the entitlement validity period.

15. A system, comprising:
a network interface that facilitates machine-to-machine communications via a communication network;
a processor coupled with the network interface; and
computer memory coupled with the processor, the computer memory comprising processor-executable instructions that, when executed by the processor, cause the processor to:
receive an entitlement redemption message comprising an entitlement identifier;
determine the entitlement identifier belongs to a valid campaign;
generate, in response to determining that the entitlement identifier belongs to a valid campaign, an electronic record for a ticket with a redeemable status, wherein the electronic record for the ticket is associated with the entitlement identifier and comprises a ticket validity period; and
cause a ticket presentation message to be transmitted to a communication device, wherein the ticket presentation message comprises an indication of the ticket validity period.

16. The system of claim 15, wherein the electronic record for the ticket further comprises a ticket redemption amount and wherein the instructions further cause the processor to:
generate a database query that includes the entitlement identifier;
transmit the database query to a database that comprises electronic records associated with a plurality of valid campaigns; and
receive a response to the database query that comprises an indication of the entitlement identifier being associated with the valid campaign, wherein the response further comprises an identification of an entitlement validity period and an entitlement amount associated with the entitlement identifier.

17. The system of claim 16, wherein the valid campaign comprises a plurality of entitlement identifiers associated therewith, wherein the entitlement identifier is included in the plurality of entitlement identifiers, and wherein the entitlement validity period is used to determine a validity period for the valid campaign.

18. The system of claim 16, wherein the ticket validity period expires after the entitlement validity period, wherein the entitlement identifier comprises a globally unique identifier (GUID), and wherein the ticket redemption amount is determined, at least in part, based on the entitlement amount.

19. The system of claim 16, wherein the instructions further cause the processor to:
update an electronic record associated with the entitlement identifier to indicate that the entitlement identifier is redeemed.

20. The system of claim 16, wherein the instructions further cause the processor to:
receive a ticket redemption message comprising the ticket identifier;
determine a time at which the ticket redemption message is received is within the ticket validity period; and
update, in response to determining that the time at which the ticket redemption message is received is within the ticket validity period, the electronic record for the ticket to indicate the ticket redemption amount has been issued from an account associated with the valid campaign.
